(19) United States
(12) Patent Application Publication
(10) Pub. No.: US 2006/0132102 A1
(43) Pub. Date: Jun. 22, 2006

(54) Maximum power point tracking charge controller for double layer capacitors

(76) Inventor: Troy Aaron Harvey, Salt Lake City, UT (US)

Correspondence Address: Troy Harvey, 7875 Davinci Drive, Salt Lake City, UT, 84121, US

(21) Appl. No.: 11/269,936

(22) Filed: Nov. 9, 2005

Related U.S. Application Data
(60) Provisional application No. 60/626,522, filed on Nov. 10, 2004.

(51) Int. Cl. H02J 7/00

(52) U.S. Cl. 320/166

(57) ABSTRACT

Disclosed is a maximum power point tracking charge controller for double layer capacitors intended for uses with non-ideal power sources such as photovoltaics.

### CROSS-REFERENCES TO RELATED APPLICATIONS

This application is a continuation-in-part of and claims priority to U.S. Provisional Patent Application No. 60/626,522 entitled “Maximum power point tracking charge controller for double layer capacitors” and filed on Nov. 10, 2004 for Troy Aaron Harvey

### BACKGROUND OF THE INVENTION

1. Field of the Invention

The present invention relates to charge controllers for double layer capacitors. More specifically the present invention relates to charging double layer capacitors from non-ideal power sources by using maximum power point tracking to achieve efficient operation. The present invention particularly addresses the charging of double layer capacitors from photovoltaic sources.

2. Discussion of Prior Art

Double layer capacitors have had limited use as bulk energy storage devices, because of their limited energy density. New technological advances (see provisional patent Nos. 60/563,311 & 60/585,393) have increased double layer capacitor (DLC) energy densities, allowing them to compete with batteries in many energy storage applications.

Particularly interesting is the application of DLCs in photovoltaic energy systems, where the increased efficiency, cycle life, and improved embodied energy of DLCs could substantially lower energy generation cost, while reducing maintenance and improving uptime.

Such DLCs are also applicable to other energy systems which use energy storage, such as wind and other environmental energy sources, as well as heat and combustion engines and turbines that are operated on intermittent basis.

However, in the current art there is no efficient means to charge a double layer capacitor from such non-ideal power sources.

### SUMMARY OF THE INVENTION

The present invention has been made taking the aforementioned problem of charging double-layer capacitors from non-ideal power sources such as photovoltaics into consideration, the object of which is to provide a single charging circuit which can efficiently charge a capacitive device while providing maximum power point tracking (MPPT) of the power source.

### BRIEF DESCRIPTION OF THE DRAWINGS

FIG. 1 shows an architectural embodiment of a system having at least one energy source, double layer capacitor(s), and a maximum power point tracking charge controller.

FIG. 2 shows another architectural embodiment of a system having at least one energy source, double layer capacitor(s), and a maximum power point tracking charge controller.

FIG. 3 shows another architectural embodiment of a system having at least one energy source, double layer capacitor(s), and a maximum power point tracking charge controller having bidirectional outputs.

FIG. 4 shows another architectural embodiment of a system having a multiplicity of different energy sources, double layer capacitor(s), and a maximum power point tracking charge controller.

FIGS. 5A and 5B shows a power flow chart of a complete system pertaining to the above architectural embodiments.

FIG. 6 shows an architectural embodiment of a charge controller and power condition circuit combined into one package.

FIGS. 7, 8 and 9 show different DC-DC converter current and voltage sense feedback embodiments.

FIG. 10A through 10C show a number of simple DC-DC converter embodiments.

FIGS. 11A through 11C show a further DC-DC converter embodiments.

FIGS. 12A through 12C show series connected DC-DC converter embodiments.

FIGS. 13A through 13C show a several possible cascaded DC-DC converter embodiments.

FIGS. 14A and 14B show two bidirectional DC-DC converter embodiments.

FIG. 15 shows a graph of photovoltaic array I-V curve and peak power under ideal conditions.

FIGS. 16 and 17 show logic diagrams for tracking the maximum power point and regulating the constant voltage charge of the double layer capacitor.

FIGS. 18 and 19 show controllers, with the DC-DC converter, sense feedback, and the rest of the system integrated together example embodiments.

### DESCRIPTION OF THE PREFERRED EMBODIMENTS

Charge Controller Architecture

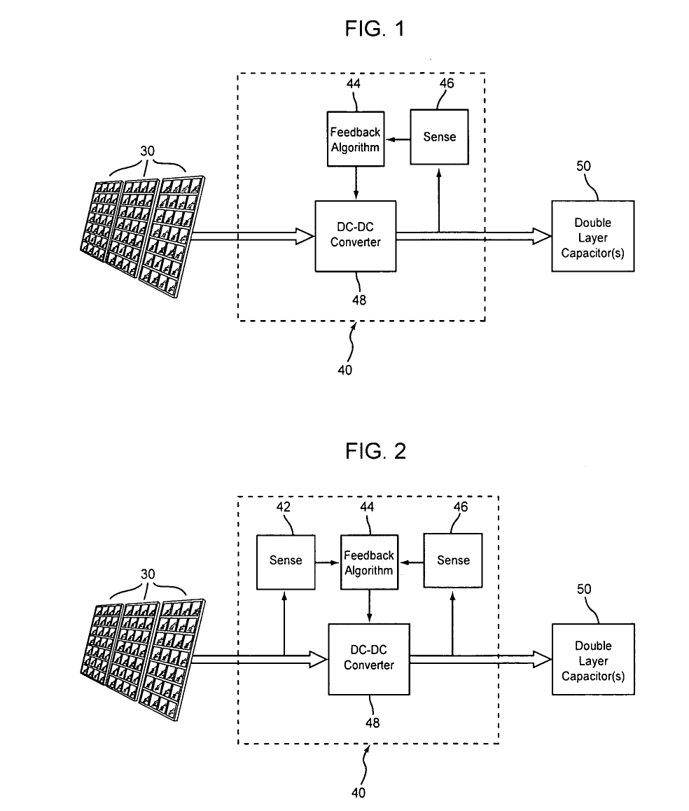

Explanation will be made below with reference to FIGS. 1-6 for illustrative embodiments concerning the general architecture of the charge controller and method of using the same according to the present invention.

In its fundamental form, as in the embodiment shown in FIG. 1, the charge controller 40 is comprised of a single DC-DC converter 48 which provides a bridge between the different voltage and current profiles of a non-ideal power source 30 (in this case a photovoltaic array) and a double layer capacitor storage 50 sub-system as to charge said capacitor bank in a efficient manner. Wherein the charge controller 40 utilizes sense 46 feedback to adjust an algorithm 44 which provides both maximum power point tracking of the non-ideal power source 30 and constant power charging of the DLCs 50. FIG. 1 shows a topology having a single sense 46 feedback on the DLC side of the DC-DC converter. The sense 46 provides voltage and current feedback and regulation of the DLC from which the power can be computed for the MPPT algorithm.

Examples of non-ideal power sources include photovoltaics, wind turbines, fuel cells, generator sets, and small turbines. The present invention is particularly suited for photovoltaic systems.

A non ideal power source, like photovoltaics will have a maximum power point at which it operates at peak efficiency. The DC-DC converter 48 is programmed by the MPPT algorithm 44 to draw power at a current and corresponding voltage (or reverse) that matches the peak power of the photovoltaics I-V curve. The algorithm constantly or periodically adjusts the conversion ratio of the DC-DC converter 48 to charge the DLC storage 50 at a constant power, equal to the available peak power of the PV array 30, changing in response to the DLCs 50 increasing variable voltage charge profile.

In the embodiment shown in FIG. 2, a variation of the basic architecture, wherein the charge controller 40, has separate sense feedback for both the supply side 42 and the storage side 46. Whereby the supply side feedback sense 42 can be used to calculate the power for the MPPT algorithm 44 to track the power source 30, and the storage side 46 can be used to regulate the DLC(s) 50 under charge. Alternatively both feedback pairs can be fed into the MPPT algorithm to the side effect.

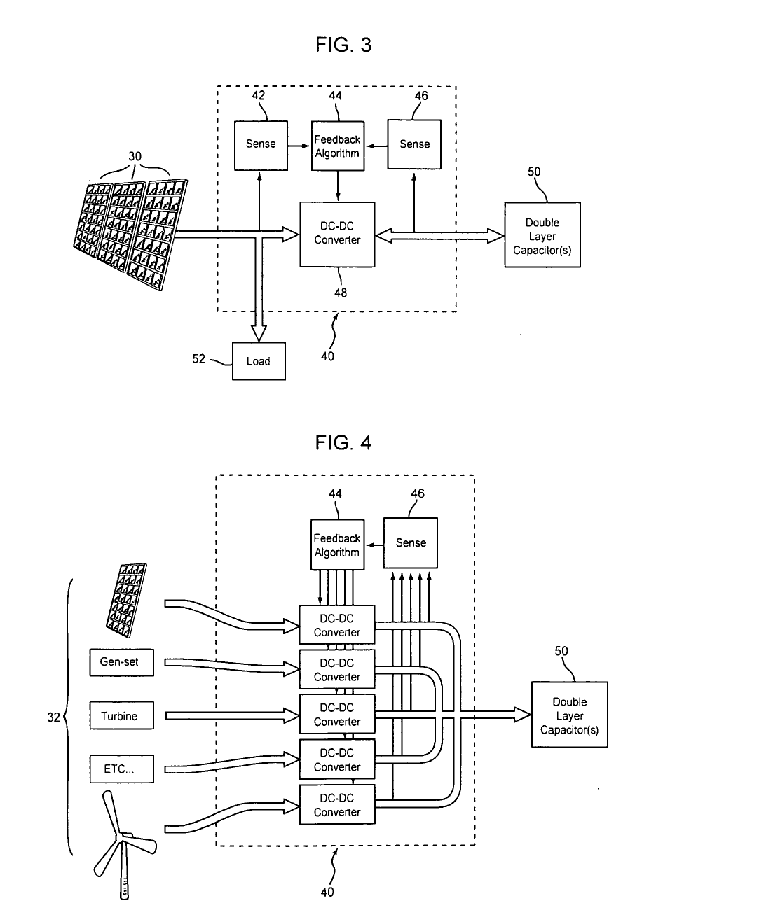

The architecture shown in FIG. 3 shows a variation of the basic architecture, wherein the charge controller 40, has bidirectional DC-DC converter 48 such that the power source can charge the DLC storage 50 in one direction, and the application load 52 can draw power from the DLC storage 50 in the other direction while using one DC-DC converter 48 circuit. In this example, as in FIG. 2, the sense 42, 46 provide feedback to the feedback algorithm to provide regulation on both sides of the DC-DC converter 48.

The architecture shown in FIG. 4 shows a variation of the basic architecture wherein multiple DC-DC converters allow the power combining of a multiplicity of separate power sources 32 each being individually MPPT tracked by a separate DC-DC converters, wherein each DC-DC converter output is combined to charge the DLC storage 50 using individual feedback sense 46 and a feedback algorithm 44 that coordinates the DC-DC converters output voltage and current regulation. In this example the charge controller is managing 5 different power sources (PV, wind, gen-set, turbine, etc). However such a implementation may also utilize multiple separate power source of the same kind, such as multiple separate PV array strings.

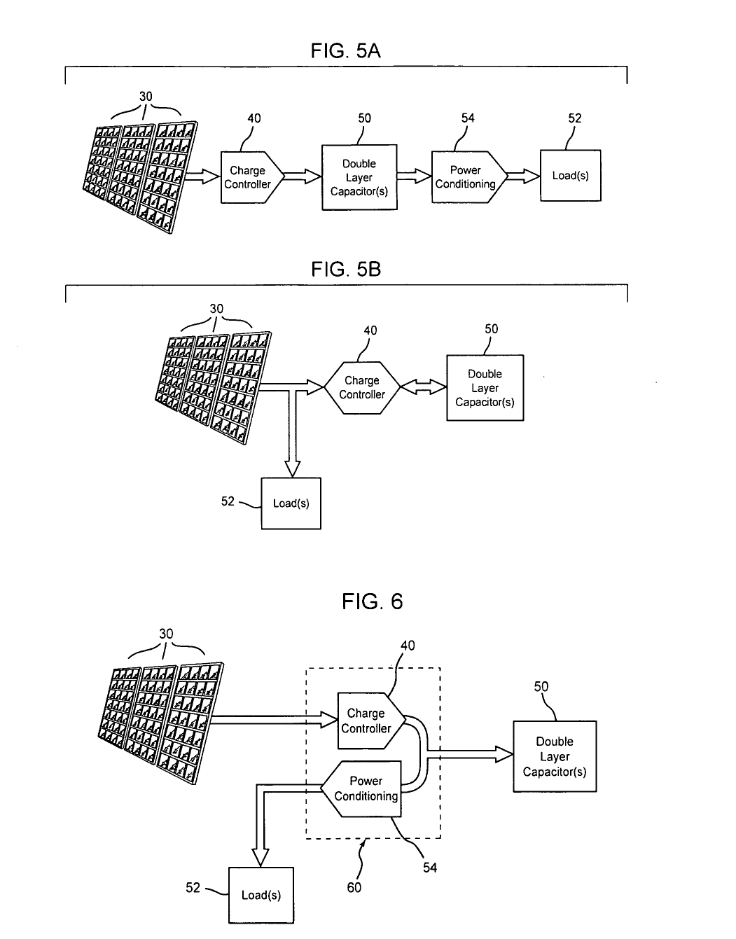

In FIG. 5A and FIG. 5B an example of a complete system overview can be seen including the system load(s) 52. The embodiment in FIG. 5A shows a charge controller having a unidirectional DC-DC converter and FIG. 5B shows a charge controller having a bidirectional controller. Wherein the unidirectional charge controller shown in FIG. 5A charges the DLC storage via the charge controller 40 from power source 30; while the load(s) 52 typically have a power conditioning 54 bridge between the load and the DLC storage. The electrical load(s) 52 may be integral to the system or external to the system. And the power conditioning 54 may include DC-DC conversion, linear voltage regulation, or AC inversion. The embodiment shown in FIG. 5B shows a bidirectional charge controller 40, wherein the charge controller matches the current between the power source 30 and the DLC storage 50, and provides matching between the DLC storage 50 and the load(s) 52 in the opposite direction while utilizing only a single circuit.

In the embodiment shown in FIG. 6, the charge controller 40 and load power conditioning 54 may be integrated into a single device 60 containing both circuits, whereby simplifying installation and use. An alternative embodiment to the one shown in the figure utilizes a bidirectional charge controller circuit with the power conditioning circuit connected to the power source side of the charge controller, whereby eliminating the efficiency loss of two conversions when the power source is directly powering the load.

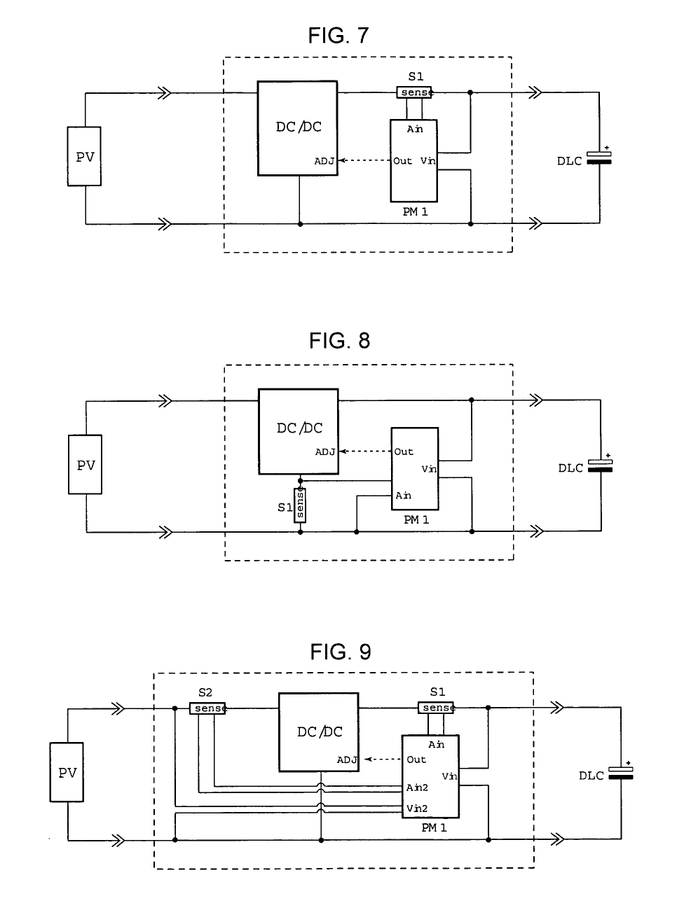

FIG. 7 shows a block diagram embodiment of the architecture shown in FIG. 1. Wherein the DC-DC converter is controlled by the pulse modulation logic PM1, which adjusts the pulse modulation output based on the feedback supplied by the current sensor S1, together with the voltage feedback across the output of the DC-DC converter. Based on the feedback supplied to Vin and Ain the pulse modulation logic adjusts the conversion ratio of the DC-DC converter via the ADJ input. Wherein the current sensor may be a resistor, hall effect sensor, transformer, or other current sensing device.

FIG. 8 shows another embodiment of the architecture shown in FIG. 1. Wherein the DC-DC converter is controlled by the pulse modulation logic PM1 which adjusts the pulse modulation output based on the feedback supplied by the current sensor S1, together with the voltage feedback across the output of the DC-DC converter. The current sensor is shown in a current mode configuration with feedback supplied by a resistor, Hall Effect sensor, or voltage drop across the switching device resistance (e.g. MOSFET). The current mode feedback doesn't require the optional voltage feedback into Vin, though voltage feedback can improve regulation accuracy. Based on the feedback supplied to Vin and Ain the pulse modulation logic adjusts the conversion ratio of the DC-DC converter via the ADJ input.

FIG. 9 shows an embodiment of the architecture shown in FIG. 2. Wherein the DC-DC converter is controlled by the pulse modulation logic PM1, which adjusts the pulse modulation output based on the feedback supplied by the DLC side current sensor S1 and the voltage readings across the output of the DC-DC converter, and the power feedback for managing the MPPT supplied by the current sensor S2 and voltage input Vin2. Based on the feedback supplied to Vin, Ain, Vin2, and Ain2 the pulse modulation logic adjusts the conversion ratio of the DC-DC converter via the ADJ input. Though the figure shows an embodiment having voltage and current feedback on the DLC side, it is only required to have either current or voltage feedback on the DLC side, given the power readings on the front side for managing the MPPT algorithm.

DC-DC Converters

The core of the charge controller, as embodied by the present invention, is a DC-DC switch-mode converter circuit which provides efficient voltage and current matching between the non-ideal power source and the DLC storage array. This matching can be the result of a boost, buck, or boost-buck circuit which is programmed to provide the required conversion ratio to match the voltage and current of the maximum power point of the power source, and the voltage of the instantaneous state of charge of the DLC array and current as required to maintain a constant power charge equal to the available power of the MPPT source. A large number of switching converter topologies are known which can increase or decrease the magnitude of the voltage and current and can be used in the present invention for the above purpose.

These include:

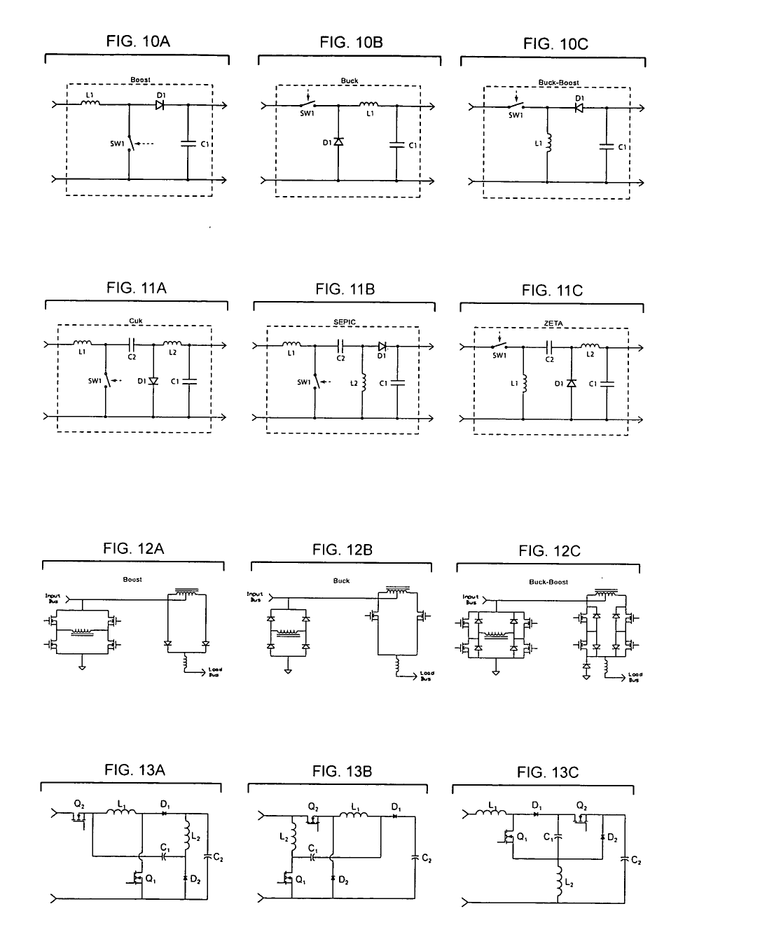

Three basic DC-DC converter topologies comprise the boost (FIG. 10A), buck (FIG. 10B), and boost-buck (FIG. 10C). These basic topologies are comprised of an inductor L1, diode D1, switch SW1 and capacitor C1 as shown in FIG. 10A-10C. The switch SW1, may be comprised of a MOSFET, transistor, IGBT, or other electronic switching device. The device conversion ratio is selected by means pulse timing and duty cycle control of the switch. Such methods include, pulse width modulation (PWM), pulse frequency modulation (PFM), and combination methodologies (such as a PWM method which utilizes PFM in low load situations).

The switching converter diode(s) D1 may be replaced with an active switch to create a synchronous-rectifier design to improve efficiency. The inductor L1 may be replaced by a transformer to provide isolation.

The converter topology is selected to correspond with the operational voltage ranges of the power source and the DLC storage. If the power source voltage operates above the DLC voltage in most cases, a buck converter may be selected. If the power source voltage operates below the DLC voltage in most cases, a boost converter may be selected. And if the power source voltage operates in an intersection of the voltage range of the DLC storage and buck-boost converter may be selected.

Any variant of the basic switching converter topologies can be utilized in the present invention.

Buck-boost variations include the Cuk (FIG. 11A), the SEPIC (FIG. 11B), and the ZETA (FIG. 11C).

Series connected variations include the series connected boost converter (FIG. 12A), the series connected buck converter (FIG. 12B), and the series connected boost-buck converter (FIG. 12C).

Switching converters can be cascaded to improve the efficiency or the component stresses of a boost-buck topology. Cascaded switch boost-buck variants include the boost-cascaded-by-buck converter (FIG. 13A), buck-interleaved-boost-buck converter (FIG. 13B), and the buck-interleaved-boost-buck converter (FIG. 13C).

The bidirectional architecture discussed above as shown in FIG. 3 uses a bidirectional DC-DC converter to provide bidirectional voltage and current matching. Two such bidirectional DC-DC converter embodiments are shown is FIGS. 14A and 14B. The embodiments show circuits having synchronous rectification, and FIG. 14B is shown with an isolation transformer, isolating the input from the output.

The DC-DC converters as described may regulate the output by a variety of methods, including power-mode, current mode, or mixed mode feedback. Current mode feedback may use slope compensation.

Other elements may be added to the DC-DC converter, such as a capacitor across the input would significantly improve performance, additional inductor or capacitor filter elements to improve noise characteristics, multi-phase implementations which reduce individual component stresses, and so forth.

MPPT Algorithms

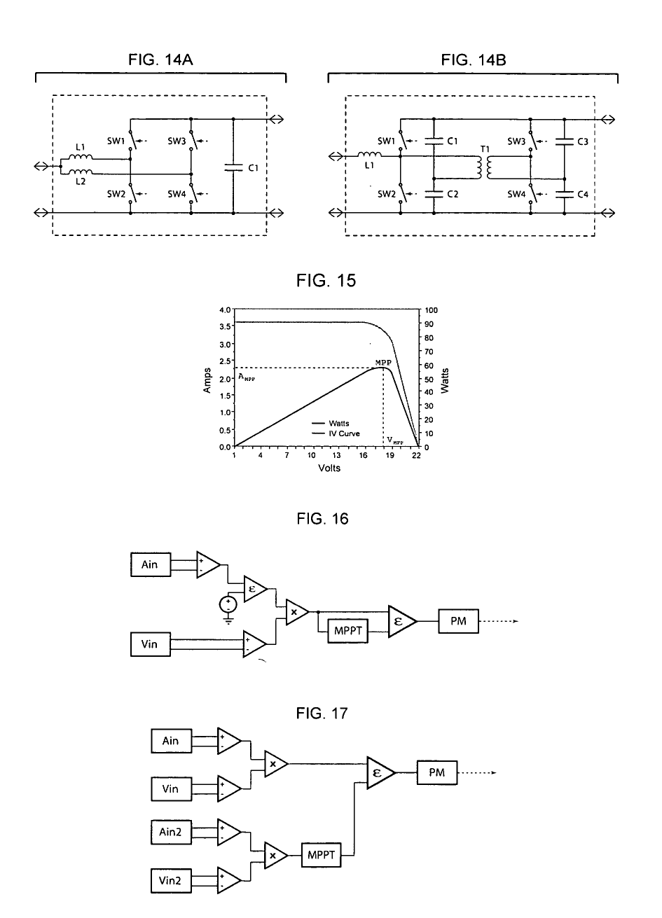

A non-ideal power source has a point at which the device operates most efficiently, such as with the photovoltaic system I-V curve shown in FIG. 15. A broad variety of MPPT algorithms can be utilized to track a non-ideal power source's maximum power point for the purposes of the present invention. MPPT methods include:

Perturb and Observe Method
Also called the hill climbing or dithering method. By periodically perturbing the source voltage (or current) and comparing the output power with that at the previous perturbing cycle. Climbs the power curve until power begins to decline again, at which point it reverses. Operation tends to oscillate around the MPP since the system must be continuously perturbed. The oscillation may be reduced by adding time delays or dynamic perturbation step size as the system approaches the peak power point. Another method to reduce oscillation is to hold the DC-DC converter at the last peak power point until the output power deviates by predetermined amount and then resume cycling.

Incremental Conductance Method
By comparing incremental conductance with instantaneous conductance, the algorithm seeks the tangent on top of the power curve where delta power/delta voltage=0.

Open-voltage or Short-Circuit Current and calculate
The operating current or voltage of source in PV arrays at the MPP is approximately linearly proportional to its open-circuit voltage or short-circuit current. So the source is periodically open-circuited or short-circuited to establish the base line, then the peak power point is estimated as a ratio from the base line.

Scan and compare
The power curve spectrum is scanned by the circuit to determine the baseline peak power point. The output of the source is then compared to the baseline peak power.

Interrupt and scan
The algorithm interrupts normal operation on a periodic basis (or due to a significant change in output power) and scans the entire power curve spectrum to seek the global maximum power point. After finding the maximum power point the converter can revert to another algorithm method such as incremental conductance or perturb and observe to provide an efficient local maximum algorithm.

Nonlinear Optimization Method
The algorithm uses a non-linear optimization model based of the system dynamics of the system using global attractors. (see: “Synthesis, simulation, and experimental verification of a maximum power point tracker from nonlinear dynamics”. Yan Hog Lim, David C. Hamill. Surrey Space Center)

Neural Network
A neural network is comprised of a matrix of independent processing elements having weighted interconnecting between each layer and the next. The connections which store information, collectively forming the tracking “algorithm”, are formed through a learning procedure. The neural network has several distinctive features, such is 1) each processing element (PE) acts independently of the others; 2) each PE relies only on local information, and 3) the large number of connections provides a large amount of redundancy and facilitates a distributed representation of information. Typical learning procedures include Hebbian, differential Hebbian, competitive learning, two-layer error correction, multilayer error backpropagation, and stochastic learning. Numerous neural network topologies and learning procedures are possible to track or adaptively track the peak power point of a PV array. (one example: “A Study on the Maximum Power Tracking of Photovoltaic Power Generation System Using a Neural Network Controller”, J. M. Kim et al. Sung Kyun Kwan University.)

Fuzzy Logic
Fuzzy logic uses the notion of membership sets where element may have partial membership in multiple sets. Fuzzy logic uses “fuzzification” to quantize feedback signals, and then assess their membership. The membership is weighted and processed using one of several heuristic methods, such as the center of gravity approach to defuzzification, thus providing a representative control value for output to the DC-DC converter. (one example is: “Maximum-power operation of a stand-alone PV system using fuzzy logic control”, Abd El-Shafy A. Nafeh et al, Numerical Modeling, 29 May 2002)

The feedback algorithm coordinates the MPPT and constant power regulation of the DLC, adjusting the DC-DC converter conversion ratio to maintain both goals. The constant power charge, as referenced to the instantaneously available power of the power source, is maintained until reaching the DLC top-of-charge at which point charging is stopped, and optionally any excess power is diverted to secondary loads.

Two examples of feedback logic diagrams are seen is FIGS. 16 and 17 are suitable for most MPPT implementations. FIG. 16 shows a logic diagram having feedback from only the output side of the DC-DC converter. The voltage and current feedback are multiplied to give a power feedback signal which is perturbed by the MPPT algorithm to generate an error signal to drive the pulse modulation logic PM.

FIG. 17 shows a system having DLC regulation inputs Ain and Vin which are multiplied to form a error signal in which to regulate the DLC constant power charging. Ain2 and Vin2 are multiplied for assessing the power source constant power to which the MPPT algorithm is applied, the output of which is used to perturb the error signal driving the pulse modulation logic PM.

Example Embodiments

The present invention may be comprised of any of the architectures described in the text pertaining to FIGS. 1 through 9, wherein the DC-DC converter circuits as shown in the architecture may be comprised of any of the switching converter topologies described in the text pertaining to FIGS. 10 through 14, and wherein the MPPT and regulation algorithm may be comprised of those described in the above section.

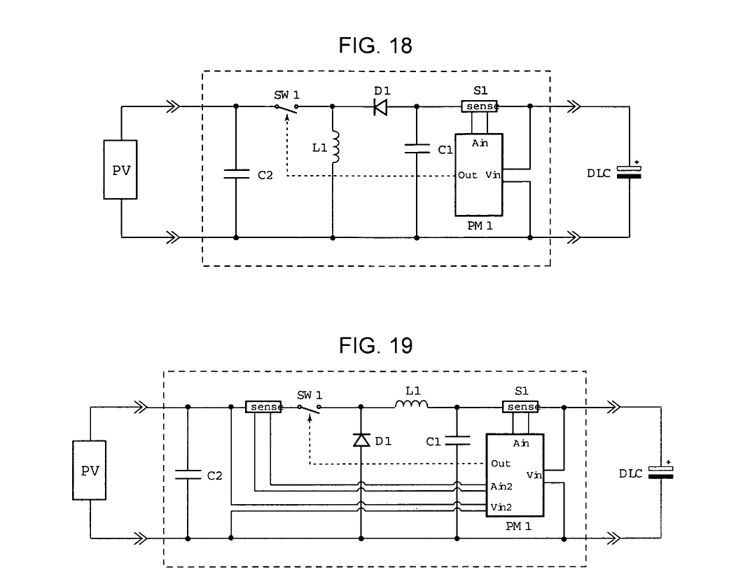

Two example embodiments of the present invention are shown in FIGS. 18 and 19. FIG. 18 shows a buck-boost DC-DC converter with DLC side voltage and current feedback into the control logic PM1. The control logic, as embodied by either discrete logic or programmed microcontroller or DSP logic, adjusts the conversion ratio of the DC-DC converter section in response to the MPPT algorithm and the DLC state of charge, by assessing the optimal power output and constant power charge feedback based on the feedback into Ain and Vin.

FIG. 19 shows a buck DC-DC converter with peak power feedback from the PV side based on the feedback into Ain2 and Vin2. The constant power charge feedback is supplied by Ain and Vin on the DLC side. The Control logic PM1 adjusts the conversion ratio based on the constant power feedback as adjusted by the peak-power algorithm based on the PV side feedback. Such a topology also provides power in and power out information by which efficiency can be assessed.

Objects and Advantages

The present invention provides a means of efficiently charging double layer capacitors from non-ideal power sources such as photovoltaics. The present invention in conjunction with recent high energy density double layer capacitor advances (see provisional patent Nos. 60/563,311 & 60/585,393), provide an efficient means to store energy from non-ideal energy sources, particularly photovoltaics and other environmental energy sources. Previous art required the use of battery storage even where capacitors have may have been utilized to augment the power performance of those batteries. The present invention provides a novel way of coupling this new class of energy storage device using only a single interface, having both MPPT and constant power charging with one circuit.

It is a matter of course that the electric double layer capacitor modules, the balancing circuitry, balancing methods, and the methods for producing the same, according to the present invention are not limited to the embodiments described above, which may be embodied in other various forms without deviating from the gist of essential characteristics of the present invention.

What is claimed is:

1. A energy system comprising a photovoltaic array, energy storage system, and a charge controller, wherein:
said energy storage system is comprised of a least one electric double layer capacitor; and
said charge controller is electrically interposed between said photovoltaic array and said electric double layer capacitor(s);
and wherein said charge controller comprises a DC-DC switched-mode converter, a photovoltaic maximum power-point tracking algorithm, and a capacitor constant-power charging algorithm; and wherein the conversion ratio of the DC-DC converter is adjusted by the aforementioned algorithms, whereby the electric double layer capacitor(s) are constant-power charged as regulated by said DC-DC converter, while simultaneously the photovoltaic array power is maintained within a margin of the maximum power-point by said DC-DC converter.

2. The DC-DC converter circuit of claim 1, wherein the DC-DC switched-mode converter provides both said maximum power point tracking and said constant power charging functionality with a single DC-DC converter circuit.

3. The DC-DC converter circuit of claim 1, wherein the DC-DC switch-mode converter topology is comprised of one of the group: boost, buck, buck-boost, Cuk, SEPIC, ZETA, series connected boost converter, series connected buck converter, series connected buck-boost converter, and bidirectional buck-boost converters.

4. The DC-DC converter circuit of claim 3 where two or more topologies are cascaded, including the topologies from the group: boost-buck cascaded converters, buck-boost cascaded converters, boost-cascaded-by-buck converters (BoCBB), buck-cascaded-by-boost converters (BuCBB), buck-interleaved-boost-buck converters (BuIBB), boost-interleaved-boost-buck converters (BoIBB), and superimposed buck-boost converters (BuSBB & BOSBB).

5. The DC-DC converter circuit of claim 1, wherein the DC-DC switch-mode converter is comprised of multiple parallel connected DC-DC converter phases or legs, whereby the individual power requirements of each converter is reduced.

6. The DC-DC switch-mode converter circuit of claim 1, wherein the DC-DC switch-mode converter switch timing is adjusted by pulse modulation electrically connected to the switching elements, wherein the pulse modulation method is selected from the group: pulse frequency modulation, current limited minimum-off-time pulse frequency modulation, power-mode pulse width modulation, current-mode pulse width modulation, current-mode pulse width modulation with slope compensation, and pulse width modulation with pulse skipping at low power load.

7. The DC-DC switch-mode converter circuit of claim 1, wherein the feedback to the pulse modulation logic may consist one from the group: voltage and current feedback on the double layer capacitor side of the DC-DC converter, voltage and current feedback on the source side of the DC-DC converter, voltage and current feedback on both sides of the DC-DC converter, and current feedback on the double layer capacitor side.

8. The maximum power point tracking algorithm of claim 1, wherein the algorithm is comprised of at least one the group: perturb and observe, incremental conductance, open-voltage and calculate, short circuit current and calculate, scan and compare, interrupt and scan, nonlinear optimization, neural network, and fuzzy logic.

9. The maximum power point tracking algorithm of claim 8, wherein the maximum power point tracking algorithm is comprised of interrupt and scan together with one of the other algorithms from said group, wherein the other algorithm provides localized tracking after the region of the maximum power point is located.

10. The capacitor constant-power charging algorithm and maximum power point tracking algorithm of claim 1, wherein the voltage and current feedback from said capacitor are multiplied to give a power feedback signal, which is then perturbed by the maximum power point tracking algorithm to generate an error signal to drive the pulse modulation of said DC-DC switch-mode converter.

11. The error signal of claim 10, wherein the error signal is further altered by one or more of: scaling factor, numerical function, or offset voltage.

12. The capacitor constant-power charging algorithm and maximum power point tracking algorithm of claim 1, wherein the voltage and current feedback from said photovoltaic array are multiplied to give a power feedback signal, which is then perturbed by the maximum power point tracking algorithm to generate an error signal that alters the capacitor DC-DC converter power feedback signal, as calculated from the multiplication of the capacitor voltage and charge current, driving the pulse modulation of said DC-DC switch-mode converter.

13. The charge controller of claim 1, wherein controller also contains one or more of voltage or current power conditioning circuitry to condition the electricity for the end-use load.

14. The power conditioning circuitry of claim 13, wherein the power conditioning comprises one or more of: linear regulator, switch-mode regulator, or AC inverter.

15. A energy system comprising a non-ideal power source, energy storage system, and a charge controller, wherein:
said non-ideal power source has an I-V curve exhibiting a maximum power point; and
said energy storage system is comprised of a least one electric double layer capacitor; and
said charge controller is electrically interposed between said photovoltaic array and said electric double layer capacitor(s); and
wherein said charge controller comprises a DC-DC switched-mode converter, a photovoltaic maximum power-point tracking algorithm, and a capacitor constant-power charging algorithm; and wherein the conversion ratio of the DC-DC converter is adjusted by the aforementioned algorithms, whereby the electric double layer capacitor(s) are constant-power charged as regulated by said DC-DC converter, while simultaneously the non-ideal power source power is maintained within a margin of the maximum power-point by said DC-DC converter.

16. The non-ideal power source of claim 15, wherein the non-ideal power source in comprised of at least one of the group: photovoltaic(s), wind turbine(s), fuel cell(s), turbine(s), internal combustion engine(s), and sterling engine(s).

17. The power source and DC-DC converter circuit of claim 15, wherein the system has a multiplicity of power sources each with its own DC-DC converter, electrically connected on the double layer capacitor side of the converters, wherein the DC-DC converters conversion ratios are coordinated such that the output voltages of the individual converters are equal and the currents are additive.
